(19) United States
(12) Patent Application Publication
(10) Pub. No.: US 2007/0226011 A1
(43) Pub. Date: Sep. 27, 2007

(54) Patient's and physicians' data management

(76) Inventors: Anuthep Benja-Athon, New York, NY (US); Theda Benja-Athon, Port Washington, NY (US); Nontawan Benja-Athon, New York, NY (US)

Correspondence Address: ANUTHEP BENJA-ATHON, 210 E 36TH ST, NEW YORK, NY, 10016, US

(21) Appl. No.: 11/803,621

(22) Filed: May 16, 2007

Related U.S. Application Data
(63) Continuation-in-part of application No. 11/114,763, filed on Apr. 27, 2005.
(63) Continuation-in-part of application No. 11/150,878, filed on Jun. 13, 2005.
(63) Continuation-in-part of application No. 11/431,046, filed on May 10, 2006.
(63) Continuation-in-part of application No. 11/293,689, filed on Dec. 5, 2005.
(63) Continuation-in-part of application No. 11/649,873, filed on Jan. 5, 2007.

(51) Int. Cl. G06Q 50/00

(52) U.S. Cl. 705/2

(57) ABSTRACT

A method of managing health and health-care data on patients by patients and physicians who insert or input health and health-care information on patients into health and health-care data in computers and servers. The information is distributed in the data and databases and retrieve to be shown in positions on pages of data on viewing screens.

This patent application is a continuation-in-part of 11/114,763 filed Apr. 27, 2005 entitled A System of Influencing Health-Care Utilizations, a continuation-in-part of 11/150,878 filed Jun. 13, 2005 entitled Physicians' Optimal Management of Health Information, a continuation-in-part of 11/431,046 filed May 10, 2006 entitled A System of Health-Care Information Management, a continuation-in-part of 11/293,689 filed Dec. 5, 2005 entitled A System of Conserving Health-Care Buyers' Resources, and a continuation-in-part of 11/649,873 filed Jan. 5, 2007 entitled A System of Calibrating Physicians' Practices of Medicine which are pending.

### FIELD OF INVENTION

A method of health and health-care data management by patients and physicians.

### BACKGROUND OF THE INVENTION

One of the fundamental and major obstacles to the resolution of the growing health-care crisis and curbing of escalation of health-care costs and worsening health-care and standard of living for almost all Americans is the lack of a system or a method of managing health and health-care information and data by patients and physicians.

The present invention representing the continual effort and research of the present patent applicants to resolve said problems provides an increasingly intelligent system and method of generating and managing health and health-care information and data of patients and, to some extent, information on the health-care services provided by said physicians by and for the benefits of said patients and physicians.

Consequently, never before in the history of humankind, the present invention will immensely and quickly improve the health, health-care and standard of living of and reduce pain, suffering and costs of health-care for millions of people.

### SUMMARY OF THE INVENTION

The present invention provides a method of generating and maintaining accurate health and health-care data on patients and health-care services provided by physicians to said patients wherein said data are generated, accessed and monitored by said patients and physicians, wherein health and health-care information is inserted by said patients, physicians and computer programs into said data present and store in the computers, and wherein said information are caused to appear in locations on pages of said data on the viewing screens of electronic devices.

### DESCRIPTION OF THE PREFERRED EMBODIMENTS

The present invention provides at least one common technological platform wherein patients and physicians generate, maintain and expand said patients' medical, health and health-care records which are accessible to said patients and physicians.

The present invention provides patients and physicians, first, with a method of generating and monitoring said patients' medical, health and health-care record and a method of expanding, enlarging or accumulating health and health-care data and databases on patients by physicians and patients inputting, adding and inserting health and health-care information on said patients by said patients and physicians into the health and health-care data and databases in the servers or computers so that said information and related information and derivatives and health and health-care data and databases are stored in said servers or computers. Said information and data are displayed or are retrieved and displayed on locations in pages on the viewing screens of electronic devices such as, but not limited to, computers, laptops, hand-held and mobile devices including wireless devices and equipment.

Said information—the components of said larger data and databases—are input, inserted or incorporated into said larger health and health-care data or databases of patients by said patients and physicians in said computers and/or servers and are retrieved and used by patients and physicians using the viewing screens of said devices. For a patient of said patients, each said entry of said information at one location of said page is followed by the appearance or appearances of said information and related information or derivatives in locations of said data and databases and, consequently, its appearance or appearances in locations or positions on a page and/or pages of said data on said viewing screens.

In other words, the present invention provides a method of automatically inserting or placing, inserting and/or distributing entries of health and health-care information of said patients in locations in the files, data and databases to effect or result in the automatic placements, insertions and/or distributions of said information and related information or derivatives in locations in said data and databases such as files, tables and fields of data and databases. Further to supra, the present invention provides a method of retrieving said health and health-care information and data from said data and databases as pages on said viewing screens of the electronic devices viewable by patients and physicians.

Second, even further to supra, the present invention provides a method of adding, editing, modifying and commenting on said entries, information, data and databases by said patients and physicians. As a consequence of supra, the present invention provides a method of inserting or placing additional health and health-care information, data and related into places in said files, data and databases of said patients by said patients and physicians and a method of retrieving said information, data and databases onto the viewing screens of the electronic devices viewable by patients and physicians. Thus, patients and physicians have a system of feedback and monitoring of said information and data based on the concept and applications of supra.

Said information and data are such as, but not limited to, vocabulary or vocabularies, words, terms, phrases, illustrations, images and pictures on and/or relate to health, health-care, medicine and surgery known to patients and use by physicians in said inputs, insertions, additions and editions are components of said larger data and databases. Said data comprise headings, topics, categories or sections such as, but not limited to, follow:
Patient's Photographs
Laboratories and Tests Data
Drug Allergies
Food Sensitivities
Medical History Summary
Medications
General Health History
Immunization History
Past Medical History or Medical History
Vital Signs
Infectious Diseases
Family History or Genetic History
Surgical History or Surgery History
Chief Complaints or Complaints
Review of Systems or Review of Organs
Differential Diagnoses
Treatments
Recommendations
Follow-Ups
and sections' relates, derivatives, equivalences and the like.

One example of one of the preferred embodiments of the present invention, the present invention provides patients using electronic devices such as, but not limited to, computers or laptops to initiate or order of displays of their data on the viewing screens of said computers. By using said viewing screens, said patients can input or insert their health and health-care information into their health and health-care data and databases in distant or remote server or servers so that said information and related information and health and health-care data containing said information are entered and stored in said server or servers. As described supra, said information and data are displayed and/or can then be retrieved to be displayed on said viewing screens and other viewing screens use by physicians.

In other words, using a patient of said patients as an example, said patient places or inserts an entry of health and health-care information in at least one location in said data present as a page on said viewing screen to effect or result in the automatic placement or placements or insertion or insertions of said information and related information in a location and/or locations in said data and databases in said server or severs. Thus, said patient will place or insert entries of information into locations in the data and databases to effect or result in the automatic placements or insertions of said information in locations in a page and locations on pages of data viewable on said viewing screens by said patient and said physicians.

Further to supra, said patient and physicians can and will add, edit, comment and the like action on said health and health-care information and data relate or pertinent to said information and data into said data and databases. As a consequence, the present invention provides a method of inserting or placing additional health and health-care information, data and related into locations or places in said data and databases of said patient and relate or pertinent to said patient and physicians and a method of retrieving said information (and said data) for placing on locations on a page and on locations on pages of said data on the viewing screens of the electronic devices.

Further more, said related information are or may be created, generated or extrapolated as a result of the inputs or insertions of said information.

An illustration of the preferred embodiments of the present invention—in a setting using a patient of said patients as an example—is represented infra by using an abbreviated and rudimentary page comprising only several sections of supra as follows:

Illustration 1:

[image]

[image]

For a patient and/or physicians, to start, by clicking Add PMH of Section VII supra said patient or physicians are shown to linked page or pages follow wherein words, terms, phrases, etc. such as, but not limited to, Heart attack can be entered into said page or pages to Section VII thus into location and/or locations in said data and databases of said patient, a result according to supra is the placement of said words Heart attack into at least two locations—Section III and Section XIV—on said illustrated page supra shown as follows:

Illustration 2:

[image]

[image]

Furthermore, using said representation of one of the preferred embodiments of the present invention, said patient and/or physicians can repetitively add treatment(s) for said Heart attack by clicking Add Rx supra to permit the insertion of treatment information into the data and databases. For example, the insertion of the word Diuretics in Section XIV also place the same word in Section IV:

Illustration 3:

[image]

[image]

Further to supra, based on the concepts and preferred embodiments supra, it is understood that information or values inserted, added or edited in one or any sections supra and related pages (not shown) can effect the insertions and placements of said values or information and related information in many files and locations in the data and databases and the placements or positions of said information or values and related information in said and other sections, headings, categories, page and pages.

Similarly, using said preferred embodiments, said patient and physicians can repetitively click Edit & Comment Data to furthermore edit, input and insert health and health-care information or values into the files, data and databases resulting in the insertions and placements of information or values in locations of a page and pages. For example, by clicking Edit & Comment Data supra pertinent to Section IV Medications, a patient and/or physicians can edit, add or insert information pertinent to medications relating to said patient into the data and databases and to show said information on medications in locations or positions in a page and locations in pages.

Said illustrations merely represent one of the preferred embodiments of the present invention. It is understood that for a patient and physicians, as much health and health-care information and data can and will be added, edited and/or commented by said patient and/or physicians from a page and pages to achieve the objectives and goals of the present invention.

Said management and manipulations of said health and health-care information, data and databases are achieved in using a network or networks of computers and servers and many available software, computer programs and languages such as, but not limited to, Structured Query Languages (SQL) such as Microsoft SQL Server, Oracle SQL, MySQL, IBM DB2, Transact-SQL, Sybase SQL, Postgre SQL, Firebird and SQLite and their derivatives, related and the like and computer programming languages such as, but not limited to, scripting programming languages such as, but not limited to, PHP, Perl, HTML and their derivatives, related and the like. Therefore, it is understood that the present invention using said hardware and software provide a method of manually—patients' and physicians' efforts—and computerized expanding and managing health and health-care data on patients by inputting or inserting health and health-care information into health and health-care data and databases on patients in the computers or servers. In other words, patients and physicians inputting or inserting health and health-care information into health and health-care data and databases on patients in the computers or servers and the displays of said information and data on the viewing screens of electronic devices imply that said physicians and patients are assisted by said software, computer programs and languages and derivatives and related.

Consequently, the present invention provides patients and physicians with accesses to said patients medical records supra and the ability to view, input, add, edit, comment, feedback and monitor on said patients' health and health-care information and data and also physicians' health-care information. Thus, patients and physicians can interact to generate and maintain the most accurate patients' medical, health and health-care records. Consequently, said patients can monitor, check and review the health-care services provided by said physicians to said patients. It is understood that data, information, software and hardware use herein are the plurals of datum, information, software and hardware.

It is understood that said descriptions, depictions and preferred embodiments apply to patients and physicians. It is further understood that said illustrations including the format, organization and layout represent only one of many illustrations of information and data on the viewing screens which the present applicants are developing and can and will develop and use. It is understood that the English language is used in and applied to the present invention in said setting of the use and applications of vocabulary or vocabularies, words, terms, phrases on and/or relate to health, health-care, medicine and surgery known to patients and use by physicians.

It is understood that, related information and data and derivatives of supra can and may be created, generated or extrapolated as a result of supra.

Although various preferred embodiments of the present invention have been described, it will be appreciated by those skilled in the art and science that adaptations and variations may be made without departing from the spirit and the scope of the claims of the present invention.

1. A method of distributing health and health-care information on patients in the health and health-care data on said patients in data and databases present and store in computers or servers and on pages of data on the viewing screens of electronic devices wherein said information and data are generated by said patients and physicians, wherein said information are input to and distributed in the data generated by said patients and physicians and are present and store in the computers or servers and are caused to appear on locations in pages of said data on said viewing screens comprises:
a process of generating health and health-care data on patients by patients and physicians;
a process of storing health and health-care data on patients in said computers or servers;
a process of inputting health and health-care information into said health and health-care data;
a process of distributing health and health-care information in said health and health-care data;
a process of showing distributed health and health-care information on pages of said data on the viewing screens of electronic devices;
a process of adding health and health-care information to said data;
a process of editing and commenting on said information; and
a process of editing and commenting on said data;
a process of showing additions, editions and comments on said health-care information and data on pages of said data on the viewing screens of electronic devices;
process of showing said information and data on pages of said viewing screens; and
a process of showing said information on locations of pages of said data on said viewing screens.

2. A method of expanding health and health-care data on patients by inputting or inserting health and health-care information on said patients into health and health-care data on said patients in the computers or servers by physicians and said patients wherein said information and data are generated by said patients and physicians, wherein said information and data are edited or commented by said patients and physicians and the editions, additions of and comments on said information are inserted or placed in said data and wherein said information in said data and said data are caused to appear in locations on pages on the viewing screens of electronic devices comprises:
a process of generating health and health-care data on patients by patients and physicians;
a process of storing health and health-care data on patients in said computers or servers;
a process of inputting health and health-care information into said health and
health-care data;
a process of distributing health and health-care information in said health and health-care data;
a process of showing distributed health and health-care information on pages of said data on the viewing screens of electronic devices;
a process of adding health and health-care information to said data;
a process of editing and commenting on said information; and
a process of editing and commenting on said data;
a process of showing additions, editions and comments on said health-care information and data on pages of said data on the viewing screens of electronic devices;
a process of showing said information and data on pages of said viewing screens; and
a process of showing said information on locations of pages of said data on said viewing screens.

3. A method of generating and maintaining health and health-care data on patients and health-care services provided by physicians to said patients wherein said data are generated and monitored by said patients and physicians, wherein health and health-care information is inputted or inserted by said patients and physicians into said data present and store in the computers or servers, and wherein said information are caused to appear in locations on pages of said data on the viewing screens of electronic devices comprises:
a process of generating health and health-care data on patients by patients and physicians;
a process of storing health and health-care data on patients in said computers or servers;
a process of inputting health and health-care information into said health and health-care data;
a process of distributing health and health-care information in said health and health-care data;
a process of showing distributed health and health-care information on pages of said data on the viewing screens of electronic devices;
a process of adding health and health-care information to said data;
a process of editing and commenting on said information; and
a process of editing and commenting on said data;
a process of showing additions, editions and comments on said health-care information and data on pages of said data on the viewing screens of electronic devices;
a process of showing said information and data on pages of said viewing screens; and
a process of showing said information on locations of pages of said data on said viewing screens.
